(19) United States
(12) Patent Application Publication
(10) Pub. No.: US 2026/0022594 A1
(43) Pub. Date: Jan. 22, 2026

(54) STORAGE COMPARTMENT LATCH FOR A STORAGE COMPARTMENT OF A VEHICLE AND STORAGE COMPARTMENT OF A MOTOR VEHICLE COMPRISING SUCH A STORAGE COMPARTMENT LATCH

(71) Applicant: Inteva Products Europe GmbH, Solingen (DE)

(72) Inventors: Stefan Wiepen, Schwerte (DE); Niklas Kock, Sprockhövel (DE)

(21) Appl. No.: 19/276,126

(22) Filed: Jul. 22, 2025

(30) Foreign Application Priority Data
Jul. 22, 2024 (DE) 10 2024 120 698.5
Jul. 22, 2024 (DE) 20 2024 104 076.7

(51) Int. Cl. E05B 83/30; B60R 7/06; E05B 81/06; E05B 81/16; E05B 81/18; E05B 81/34

(52) U.S. Cl. CPC E05B 83/30; B60R 7/06; E05B 81/06; E05B 81/16; E05B 81/18; E05B 81/34

(57) ABSTRACT

A storage compartment latch for a storage compartment of a vehicle comprises a housing, at least one locking bolt which is displaceably mounted in the housing and which can be selectively transferred into a position retracted in the housing or a position extended from the housing, an electric drive arranged in the housing with an electric motor and a worm gear driven by the electric motor, and a lever element which is pivotally mounted in the housing and which is directly operatively connected to the worm gear in such a way that a rotational movement of the electric motor is converted directly into a pivoting movement of the lever element via the worm gear, wherein the lever element is further operatively connected to the at least one locking bolt in such a way that a pivoting movement of the lever element is converted into a displacement movement of the at least one locking bolt.

### CROSS REFERENCE TO RELATED APPLICATIONS

This application claims priority under 35 U.S.C. § 119 to the following German Patent Application No. 10 2024 120 698.5, filed on Jul. 22, 2024 and German Utility Model Patent Application No. 20 2024 104 076.7, filed on Jul. 22, 2024 the entire contents each of which are incorporated herein by reference thereto.

### BACKGROUND

The present application relates to a storage compartment latch for a storage compartment of a vehicle and a storage compartment of a vehicle comprising such a storage compartment latch.

Motor vehicles include a variety of storage compartments and stowage options in the interior of a motor vehicle, which can be used to store small items such as drinks, documents, keys, mobile phones, and the like, and can also contain other functional elements such as cup holders, USB ports, and the like. The storage compartments and stowage options can be integrated into the interior trims of a motor vehicle or provided in other areas of a passenger compartment.

For example, a glove compartment is generally integrated into a motor vehicle's dashboard, providing storage space that can be opened or closed via a flap. Furthermore, armrests are common, which can be provided in a center console, for example, and feature a hinged cover flap that can be folded into an open position, providing access to the storage space of the armrest, and a closed position, in which the storage space of the armrest is closed.

Various locking or latching systems are known for storage compartments that can be closed using a flap, which serve to either latch the flap to the storage compartment housing or to release it from the latter. In the simplest case, latches can be provided with a detent function that holds the flap in position by engaging it with the storage compartment housing. Latches with a clamping function have also been used to latch the cover flaps of storage compartments, such as glove compartments, for example, by rotating an operating handle through 180°. In this case, a latching tongue can be located behind a type of frame, and a subsequent axial clamping stroke presses the latching tongue securely against the latter. Manual latching systems can function properly, but are less suitable for use in modern, and particularly high-quality, motor vehicles. They offer little operating comfort and can be damaged if operated incorrectly by the user, for example if the user exerts excessive force. Furthermore, unauthorized persons can quickly gain access to the storage space.

Electrically operated latching systems with a locking mechanism are also known in practice, which actuate a locking bolt, for example via a pull magnet or via an electric motor with a downstream power transmission mechanism, in order to unlatch it optionally. The unlatching can be triggered by the driver by pressing a switch, a button, or the like. Such latching systems can simplify operation for the user and offer a certain level of access security. However, they generally comprise many components, which can result in considerable component and installation effort and expense. There is a need for less complex electrically operated latching systems that can be manufactured and installed easily and inexpensively and that provide the required reliability and security when latching and unlatching a flap of a storage compartment.

### BRIEF SUMMARY

Based on this, it is an object of the present disclosure to improve the latching systems known from the prior art and, in particular, to provide a storage compartment latch for a storage compartment of a vehicle and a storage compartment of a motor vehicle with such a storage compartment latch, which offer the convenience and safety of an electrical actuation with a construction that comprises as few components as possible and can be manufactured and assembled easily and inexpensively, so that they are suitable for applications in vehicles, in particular motor vehicles.

This object is achieved by a storage compartment latch for a storage compartment of a vehicle having the features of independent claim 1 as well as a storage compartment of a vehicle having the features of further independent claim 17. Particularly preferred embodiments are specified in the dependent claims.

According to a first aspect of the present disclosure, a storage compartment latch for a storage compartment of a vehicle is provided, comprising a housing, at least one locking bolt, an electric drive, and a lever element. The at least one locking bolt comprises a base body, which is displaceably mounted in the housing, for example along its longitudinal extent, and a bolt head which is firmly connected to the base body, preferably formed integrally therewith, and which, by displacing the base body, can be transferred either into a fully extended position, in which it protrudes maximally from the housing, or into a fully retracted position, in which it is at least largely inserted into the housing. The electric drive is arranged in the housing and comprises an electric motor and a worm gear driven by the electric motor. The lever element is pivotally mounted in the housing and directly operatively connected to the worm gear in such a way that a rotational movement of the electric motor is directly converted into a pivoting movement of the lever element via the worm gear. The lever element has a lever arm which engages with the base body of the at least one locking bolt in order to convert a pivoting movement of the lever element into a displacement movement of the at least one locking bolt.

Thus, a storage compartment latch for a storage compartment of a vehicle, preferably a motor vehicle, is provided, which comprises only a few components and is constructed in a relatively simple and cost-effective manner, so that the component and cost expenditure are significantly reduced compared to conventional electrically operated latching systems of vehicle storage compartments, while offering the user ease of handling, high operating comfort, and a high level of security. Advantageously, the unlatching process requires no force and no assistance from the user. The user can easily, quickly, and conveniently trigger or control the unlatching process by means of an input, for example via an actuation switch, a button on a control panel, for example on a touch-sensitive screen or touchscreen of a combined input and/or output device of the vehicle, via remote control, voice control, or by other means. The electrical actuation using the electric drive and the lever element ensures reliable unlatching of the at least one locking bolt. Advantageously, only the driver or other authorized persons, for example after an access check of the vehicle, can trigger the unlatching of the storage compartment. The storage compartment latch is well suited for use in the automotive sector.

As used herein, “directly operatively connected” means that no additional means or transmission elements are arranged between the worm gear and the lever element to transmit power. The lever element is thus immediately, directly connected to the worm gear. This allows the number of components interacting for power transmission and motion conversion to be reduced, which in turn results in reduced backlash and noise. The simple power transmission mechanism according to the present disclosure enables high efficiency, robustness, and reliability in operation.

In one embodiment, the housing of the storage compartment latch can comprise a base plate, a side wall firmly connected to the base plate, and a housing cover that is detachably connected to the side wall and the base plate. For example, the detachable connection can be realized via latching means, such as latching eyes with associated latching lugs. In principle, a screw connection is also possible, albeit more complex. The base plate, the side wall, and the housing cover define an interior space between them, in which the components of the storage compartment latch are housed. The housing can have an opening on a front side through which the bolt head can protrude outwards from the interior of the housing in the latched position to achieve the latching function. The housing parts can be manufactured inexpensively, preferably from plastic, for example by injection molding or thermoforming. It is understood that the housing parts can also be made of other materials, such as sheet metal, steel, or the like, and can each comprise several prefabricated parts, which can be joined together by gluing, welding, or other joining methods.

In one embodiment, the base body of the at least one locking bolt has an elongated, straight cylindrical shape and can carry guide strips extending along its longitudinal extent on two opposite sides, which are displaceably guided in guide rails formed on the housing. The guide rails can be provided on the base plate and/or the side wall of the housing and preferably formed integrally thereon. This simplifies production, and no additional parts are required for the guide device.

The bolt head of the at least one locking bolt can be wedge-shaped with a locking surface and an inclined run-up surface opposite the locking surface. When a cover flap of the storage compartment is closed, the run-up surface interacts, for example, with a striker part or other locking part attached to the cover flap in order to push the at least one locking bolt into the housing and into its fully retracted position, in particular against the action of a preload spring or the like. The locking surface interacts with the striker part or other locking part to keep the cover flap securely closed in the latched position and to prevent accidental or unauthorized opening of the cover flap without triggering the unlatching process.

In an advantageous further embodiment, the at least one locking bolt can carry a lug projecting beyond a surface of the base body, which can be arranged and configured to engage the lever element. Preferably, the lug is directly engaged with the lever element, wherein “directly engaged” means that the lever element immediately, directly engages and acts against the locking bolt, in particular the lug. No means are interposed, so that the construction requires few parts and is simple and cost-effective. In principle, the lever element could also engage indirectly, via a coupling element, with the at least one locking bolt, in particular the lug on the base body, for example if the storage compartment latch contains two locking bolts. The lug can preferably be manufactured in one piece with the base body. Alternatively, although less preferred, it could also be manufactured separately and attached to the base body. Other sections of the locking bolt could also be configured to engage with the lever element.

In advantageous embodiments, the at least one locking bolt can be preloaded toward its extended position by a preloading device, in particular a compression spring. The preloading device can, for example, press the at least one locking bolt directly against the lever element and hold it in contact with the latter, thus counteracting a displacement movement of the locking bolt into the housing and a corresponding pivoting movement of the lever element. The preloading device can also enable the locking mechanism to be reset.

In particular, in a particularly preferred embodiment, the worm gear can be designed as a non-self-locking worm gear so that forces and movements can be transmitted or converted in both directions from the motor to the at least one locking bolt and vice versa. By rotating the motor, the lever element can be pivoted in such a way that the locking bolt is pulled into the housing, or conversely, the preloading force of the preloading device can act without motor actuation to move the locking bolt out of the housing and thereby pivot the lever element back in the opposite direction. The pivoting-back movement can then be converted via the non-self-locking worm gear into a rotation of the drive shaft in the opposite direction to the drive movement. In any case, the lever element can be returned to its initial position.

In an advantageous embodiment, the worm gear comprises a worm shaft formed by a helical output shaft of the electric motor, or a worm gear mounted on the output shaft of the electric motor in a rotationally fixed manner and a worm wheel element, which is formed directly on the lever element, forming a single piece with it. No separate worm wheel is required. The lever element is formed integrally with the worm wheel element and is formed in one piece as a single component, thus reducing the number of components.

In an advantageous implementation, the worm wheel element can be formed on the lever element as a gear wheel segment that is delimited by a segment angle range that is greater than 0° and less than 45°, preferably less than 30°, particularly preferably less than 20°. The gear wheel segment therefore does not cover the entire circumference of the gear wheel, but rather forms only a section or part of it. The segment angle range spanned by the gear wheel segment is very small, so that the worm wheel element is also significantly smaller compared to a solid gear wheel and requires less installation space. The construction is light and simple.

Particularly advantageously, the lever element can be configured as a two-sided lever element, comprising the (first) lever arm, which is preferably in direct engagement with the at least one locking bolt, and a further (second) lever arm, which is operatively connected to the worm gear and on which the gear wheel segment is formed. The two-sided lever enables forces to be transmitted very efficiently, loads to be balanced, and, in the case of a non-self-locking worm gear, movements to be transmitted in both directions from the worm gear to the at least one locking bolt and vice versa.

An emergency unlatching for the storage compartment latch can be implemented in order to be able to unlatch the storage compartment latch if necessary in the event of a failure of the electric motor or the power supply. For this purpose, in one embodiment, the further lever arm can carry a projection that can protrude in a direction substantially perpendicular to a pivoting plane of the lever element, and the housing, for example the housing cover, can have a through-opening through which the projection can be accessible from the outside. For example, the projection can be located opposite the through-opening or even protrude outwards through the through-opening, so that it can be grasped and pivoted by hand or with a tool from the outside to enable the emergency unlatching.

In a configuration of the storage compartment latch of any of the aforementioned embodiments, the at least one locking bolt can be the single locking bolt of the storage compartment latch, and the lever element can then preferably be in direct engagement with the single locking bolt. For example, the lever arm of the lever element can directly engage with the lug formed on the locking bolt. Without any interposed elements, the design can be implemented particularly simply and cost-effectively, with few parts, and in a compact form. This also provides the basis for high reliability and durability of the design.

In another configuration of the embodiments of the storage compartment latch described above, the at least one locking bolt can have a first elongated locking bolt and a second elongated locking bolt. The two locking bolts can be arranged parallel and spaced apart next to one another and displaceably mounted in the housing. Preferably, each locking bolt is preloaded towards its extended position by its own separate preloading device, for example a compression spring. Thus, each locking bolt can be configured to be pressed into the housing independently of the other when subjected to external force, without affecting the state of the other locking bolt. This can be particularly advantageous in the case of double-leaf cover flaps of armrests in order to be able to close the two halves of the cover flap independently of one another.

In order to be able to unlatch the first and second locking bolts together and simultaneously in the configuration described above, an advantageous embodiment provides for a coupling element, which is displaceably mounted in the housing and is operatively coupled between the lever element on the one hand and the first and second locking bolts on the other hand. This allows a pivoting movement of the lever element to be converted via the coupling element into a coupled displacement movement of both the first and the second locking bolts. However, the first and the second locking bolts are each arranged to be able to be pushed into the housing independently of the other locking bolt and the coupling element when an external force acts on their associated bolt head. Both locking bolts can then be unlatched together and simultaneously and latched independently of one another.

In a further development, the coupling element can be configured for emergency unlatching of the storage compartment latch. For this purpose, a portion of the coupling element can be accessible from the outside through a through-opening in the housing, so that it can be grasped and moved from the outside, if necessary with a tool, in order to move the first and second locking bolts into their fully retracted position as needed and enable emergency unlatching.

The storage compartment latch according to the present disclosure offers a user the option of requesting and effecting automatic unlatching of the storage compartment latch by means of an input in order to open the storage compartment. The input can be made by touching a touch switch or touch pad on an input unit, for example on the vehicle's instrument cluster, by a voice command, a movement command, or the like. In order to accomplish the automated unlatching, a control device is preferably provided which is assigned to the storage compartment latch and is configured to receive an input signal which indicates the operator's desire to open the storage compartment and then to cause the electric motor to be suitably energized. The input signal can originate from a sensor detecting the driver's input. The control device can cause the electric motor to advantageously be supplied with a current pulse of limited duration, for example 30-70 ms, preferably approximately 50 ms, in order to cause the bolt head to be moved into the fully retracted position. Once this position is reached, a suitable mechanism, such as a spring-loaded or motor-driven mechanism, can ensure that the cover flap of the storage compartment is automatically transferred to an at least slightly open position, whereupon the cover flap can be fully opened to gain access to the storage space. The mechanism can also fully open the cover flap.

When the control system interrupts the power supply to the electric motor again after the limited duration, the at least one locking bolt can be automatically returned to its extended position by the associated preloading device, for example a compression spring. At the same time, the lever element is also pivoted back to its initial position. This is permitted by the non-self-locking worm gear of the electric drive.

According to a further aspect of the present disclosure, a storage compartment of a vehicle, in particular a motor vehicle, is provided, which comprises a storage compartment housing, at least one cover flap, a storage compartment latch, and a locking part. The storage compartment housing defines a cavity that forms the storage space. The cover flap is movably arranged on the storage compartment housing such that the cover flap can be moved between an open position, in which the cavity is open to the outside, and a closed position, in which the cavity is closed to the outside. For example, the cover flap can be pivotally mounted about a horizontal axis. The storage compartment latch is constructed according to any of the embodiments described above and is attached to one of the cover flap and the storage compartment. The locking part is arranged to cooperate with the bolt head of the at least one locking bolt of the locking latch in order to latch the cover flap in the closed position. The locking part is attached to the other of the cover flap and the storage compartment housing. Preferably, the storage compartment latch is attached to the storage compartment housing, while the locking part is attached to the cover flap. The reverse arrangement is also possible.

The locking part can, for example, be a striker part or a hook part which includes a receiving opening for receiving the bolt head of the at least one locking bolt in the closed position and a wall or a bracket or hook section which delimits the receiving opening and which engages with the locking surface and the run-up surface of the bolt head in order to enable the proper operation of the storage compartment latch as described herein.

The storage compartment can be any compartment or cavity for storing objects in a vehicle, which can be closed by a cover flap. In particularly preferred applications, the storage compartment can be a glove compartment formed in a dashboard of a motor vehicle. It can also be a separate component that can be inserted into the dashboard. In further preferred applications, the storage compartment can be an arm support or an armrest, which is provided, for example, in an area of a center console or a rear seat console of a motor vehicle and comprises a lockable storage space. A storage compartment latch with two locking bolts is particularly suitable for double-leaf armrests that have two cover flaps or lid halves that cover different areas of the storage space. The two cover flaps or lid halves can be unlatched and opened together at the push of a button or the like and can be closed and latched again independently of one another.

The different embodiments of the storage compartment latch according to the present disclosure can be implemented in the storage compartment according to the present disclosure, and their advantages, in particular the simple and cost-effective construction, the easy handling and the operating comfort, also benefit the storage compartment as a whole.

### BRIEF DESCRIPTION OF THE DRAWINGS

Further advantageous embodiments of the present disclosure emerge from the claims, the following description of preferred embodiments, and from the drawings.

The drawing depicts exemplary embodiments of the subject matter of the present disclosure, which are in no way limiting. Where possible, the same reference signs are used throughout the figures to designate the same parts or components, whereby, unless otherwise specified, the same explanations apply to all figures. In the figures:

FIG. 1 is a perspective view of a section of a vehicle interior with an opened glove compartment and with a storage compartment latch according to an embodiment of the present disclosure to illustrate a preferred field of application of the present disclosure, in a highly schematic representation;

FIG. 2 is a perspective view of a storage compartment latch according to an embodiment of the present disclosure in an assembled state;

FIG. 3 is an exploded view of the storage compartment latch according to FIG. 2;

FIGS. 4a-4c show a storage compartment latching system with the storage compartment latch of the embodiment according to FIG. 2 and FIG. 3 in a latched position, an unlatched position and an open position to illustrate an unlatching and opening of a storage compartment, in a schematic plan view from the front;

FIGS. 5a-5b show the storage compartment latching system according to FIG. 4 in a latched closed position and an unlatched open position, in a cross-sectional view;

FIGS. 6a-6c are plan views of the storage compartment latching system according to the present disclosure in views similar to FIGS. 4a-4c to illustrate a closing and latching process;

FIG. 7 is a perspective view of a section of an armrest with a storage compartment latch according to a further embodiment of the present disclosure to illustrate a further field of application of the present disclosure, in a sectional schematic representation;

FIG. 8 shows a cross-section through the armrest and the storage compartment latch according to FIG. 7, in a schematic sectional representation;

FIG. 9 is a perspective view of the storage compartment latch of the further embodiment according to FIG. 7 and FIG. 8 in an assembled state;

FIG. 10 is an exploded view of the storage compartment latch of FIG. 9;

FIGS. 11a-11c show the storage compartment latch of the further embodiment according to FIGS. 7-10 in different positions to illustrate an unlatching and opening process; and

FIGS. 12a-12b are perspective views of the locking latch of the further embodiment according to FIGS. 7-11 to illustrate different closing and latching processes.

### DETAILED DESCRIPTION

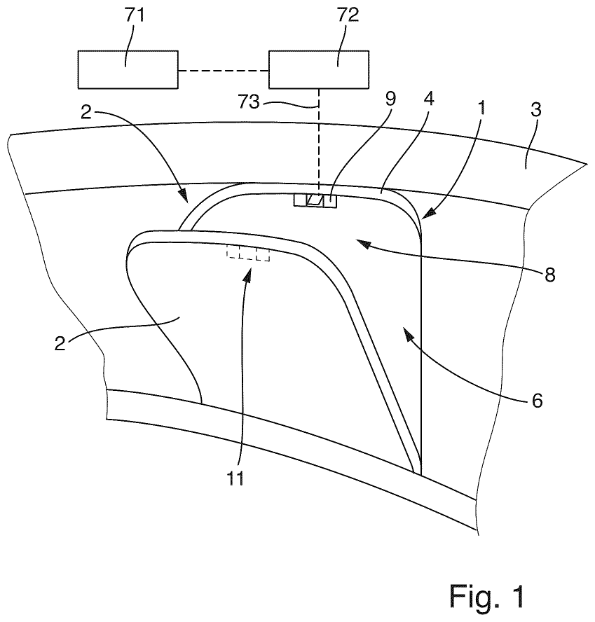

FIG. 1 shows a highly schematic representation of a storage compartment 1 in the form of a glove compartment 2, which is arranged in a dashboard 3 of a motor vehicle, to illustrate an environment in which the present disclosure can be used. The glove compartment 2 has a storage compartment housing 4, which here is integrally formed in the dashboard 3 or can also be a separate component that is inserted into the dashboard 3. The storage compartment housing 4 defines a cavity 6 in its interior, which can be used as storage space for storing objects such as documents, wallets, keys, mobile phones, or the like.

The glove compartment 2 further comprises a flap 7, which can also be referred to as a cover flap, and serves to open or close the cavity 6 to the outside as needed. For this purpose, the flap 7 can be pivotally mounted on its underside on the storage compartment housing 4 about a horizontal axis, which is not shown in detail here.

In order to keep the flap 7 securely closed in its folded position, in which the cavity 6 is closed, a storage compartment latching system 8 is provided, which comprises a storage compartment latch 9 and a locking part 11, which interact with one another to latch the flap 7 in the closed position. In the present case, the storage compartment latch 9 is attached to the storage compartment housing 4, while the locking part 11 is attached to the flap 7. Conversely, however, the storage compartment latch 9 can also be attached to the flap 7 and the locking part 11 to the storage compartment housing 4. Incidentally, the positions at which the storage compartment latch 9 and the locking part 11 are shown here are only exemplary, and they could be positioned at any desired positions on the glove compartment 2, for example, also on the vertical sides of the glove compartment 2. Furthermore, the design of the glove compartment 2 and the dashboard 3 shown in FIG. 1 is merely exemplary, and many different designs can be chosen for them. The glove compartment 2 could, in principle, also be designed like a drawer, and the flap 7 could then be attached to the drawer element so that it can slide relative to the storage compartment housing 4.

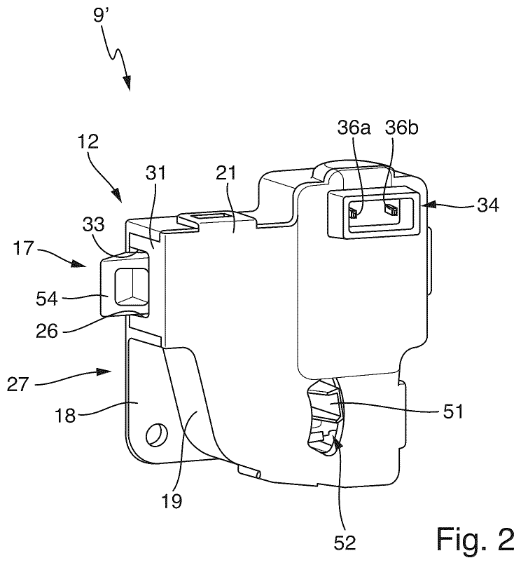

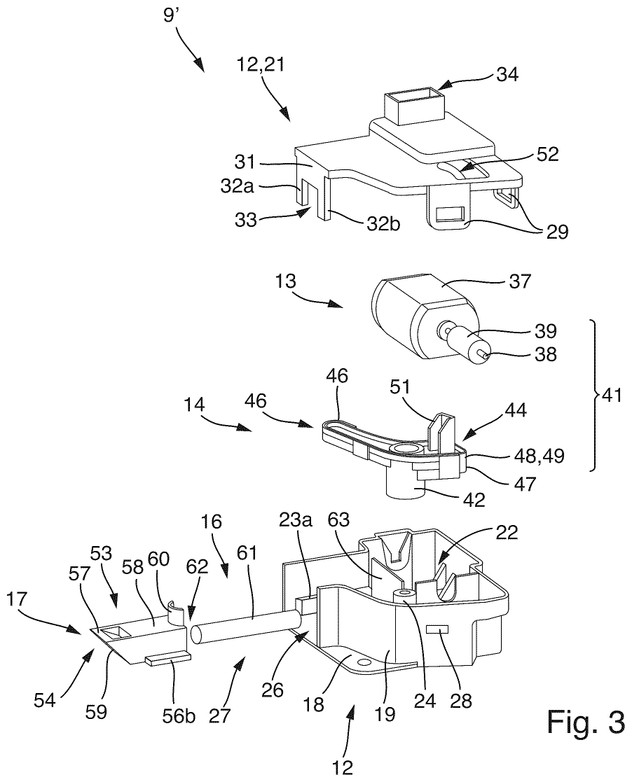

Referring now to FIGS. 2-6, a storage compartment latch 9′ for a storage compartment latching system 8 according to a first embodiment of the present disclosure is illustrated there. As can be seen in particular from the perspective view of the assembled storage compartment latch 9′ according to FIG. 2 and the exploded view according to FIG. 3, the storage compartment latch 9′ has a relatively compact, simple, and cost-effective design with few components, which essentially include a housing 12, an electric drive 13, a lever element 14, a preloading device 16, and a locking bolt 17.

The housing 12 comprises a base plate 18, which is also designed to fasten the storage compartment latch 9′ to a support structure, such as the storage compartment housing 4, for example by screwing, a side wall 19, which is firmly connected to the base plate 18 and projects essentially perpendicularly from the base plate 18, and a housing cover 21, which is arranged on the side of the side wall 19 facing away from the base plate 18 and can be detachably connected to the side wall 19. The base plate 18, the side wall 19, and the housing cover 21 define between them an interior space 22 of the housing 12, in which the components of the storage compartment latch 9′, i.e. the electric drive 13, the lever element 14, the preloading device 16, and at least a large part of the locking bolt, are accommodated in a protected manner. The entire housing 12 can be made of plastic, for example, injection-molded or thermally formed.

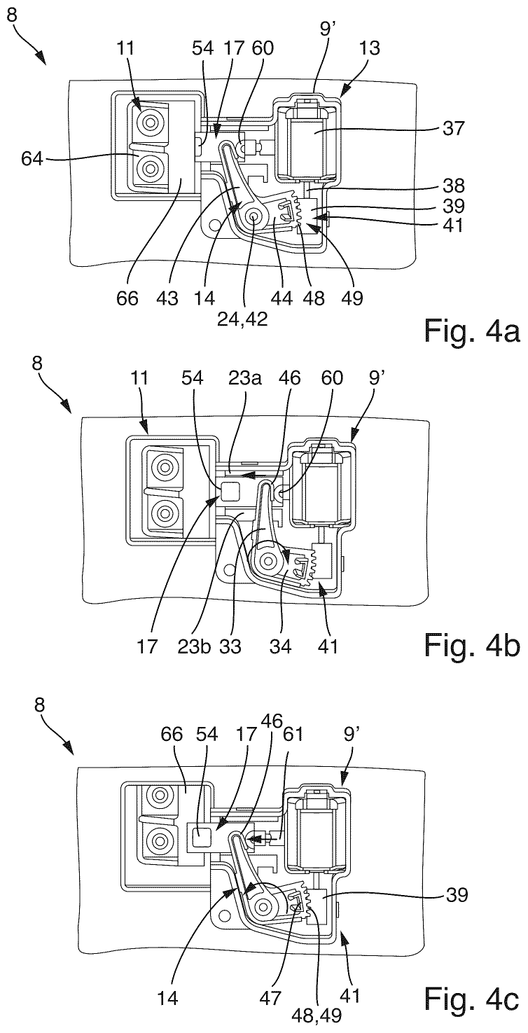

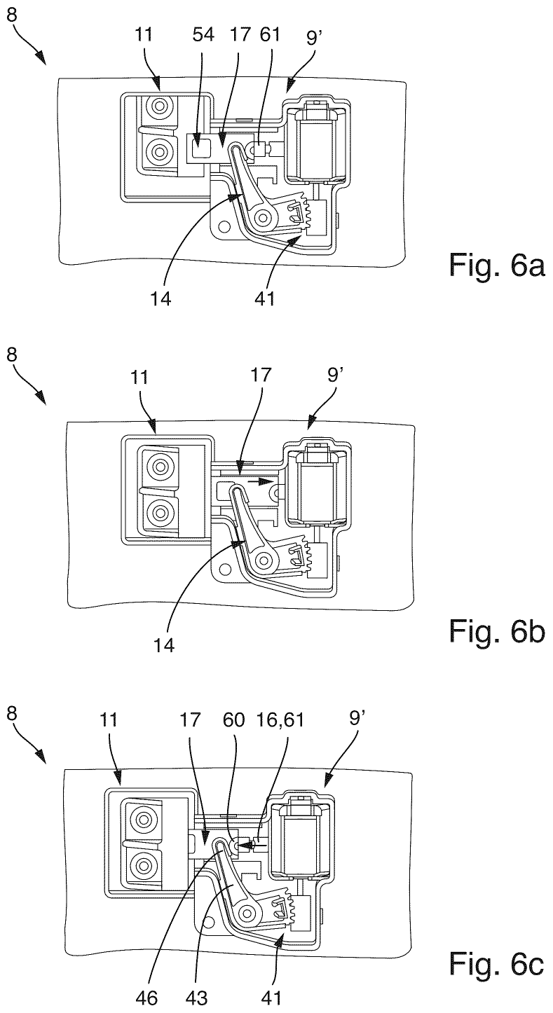

As can also be seen from FIGS. 4a-4c and 6a-6c, the base plate 18 has two guide rails 23a, 23b, which are spaced apart and run parallel to one another and provide linear guidance for the locking bolt 17 in the interior space 22. Furthermore, the base plate 18 carries a pivot pin 24, which provides a fulcrum or pivot point for the lever element 14. The guide rails 23a, 23b and the pivot pin 24 can advantageously be integrally formed on the base plate 18.

The side wall 19 extends around the circumference of the base plate 18, essentially along all sides thereof, except for a recess 26, visible in FIGS. 2 and 3, which the side wall 19 leaves free on a front side 27 of the housing 12 facing the locking part 11 during operation. The recess 26 allows the locking bolt to protrude outwards from the interior space 22 for latching purposes. Latching lugs 28 can be formed on the side wall 19, which enable the housing cover 21 to be detachably fastened to the side wall 19 by latching.

The housing cover 21 has a contour corresponding to the outline of the side wall 19 in order to close the interior space 22 to the outside when the housing cover 21 is secured to the side wall 19. Latching eyes 29 can be formed on the housing cover 21, which enable a latching connection with the latching lugs 28. A reverse arrangement could also be selected, with latching lugs formed on the housing cover 21 and latching eyes or latching tongues formed on the side wall 19. The housing cover 21 could also be detachably fastened to the side wall 19 or the base plate 18 by screwing, press fitting, or other detachable connection techniques.

A claw 31 is formed on a side of the housing cover 21 associated with the front side 27 of the housing 12, which protrudes substantially perpendicularly from the plane of the housing cover 21 and is positioned in such a way that, in the installed state according to FIG. 2, it is received in the recess 26 of the side wall 19. The claw 31 contains two mutually parallel and spaced-apart fingers 32a, 32b, which define an opening 33 between them, which allows the locking bolt 17 to protrude outwards from the interior space 22 of the housing 12. The opening 33 is preferably suitably dimensioned to guide the locking bolt 17 with little play.

Furthermore, a connector 34 is provided on the housing cover 21, which is designed here in the manner of a connection socket and comprises connection contacts 36a, 36b, which are connected to the electric drive 13 for power supply via electrical lines not shown in detail here. A suitable plug of a power line (not shown) can be connected to the connector 34 in order to supply the electric drive 13 with electrical energy.

The electric drive 13 has an electric motor 37, whose output shaft 38, in the illustrated exemplary embodiment, carries a worm wheel 39, which is shown only schematically here and is part of a worm gear 41. The output shaft 38 could also be helical itself and form a worm shaft. The electric motor 37 is a direct current motor, which preferably has a nominal voltage of 12 volts, which corresponds to the on-board voltage of a motor vehicle. For the actuating movements of the lever element 14 and the locking bolt 17 required here, the electric motor 37 can be designed for a relatively low power of less than 100 W, preferably even less than 50 W.

In the preferred embodiment shown, the lever element 14 is designed as a two-sided lever having a hollow shaft 42, which is rotatably mounted on the pivot pin 24 of the base plate 18, a first lever arm 43, and a second lever arm 44. The first lever arm 43 projects away from the hollow shaft 42 in a first direction, and the second lever arm 44 projects away from the hollow shaft 42 in a second direction, which is different from the first direction and can, for example, be oriented perpendicular to the first direction. The first lever arm 43 has a first free end 46, which is intended to engage with the locking bolt 17. The second lever arm 44 has a second free end 47, which is formed here with a gear wheel segment 48, which forms a worm wheel element 49 of the worm gear 41. The thread of the worm shaft or worm wheel 39, which is not shown in the figures for simplicity, engages the tooth gaps of the worm wheel element 49, which is formed here by the gear wheel segment 48. The gear wheel segment 48 is advantageously formed integrally with the second lever arm 44 as a single component, thus reducing the number of components.

The gear wheel segment 48 comprises only a section or part of an entire gear wheel, so that installation space and weight can also be saved. In the illustrated embodiment, the segment angle range encompassed by the gear wheel segment 48 can be in the range between 0° and 45° and can preferably be less than 30°. In particularly preferred embodiments, the segment angle range can be less than 20°. With the construction according to the present disclosure, a pivoting of the lever element 14 by an angle of less than 20° may be sufficient to cause unlatching of the storage compartment latch 9′.

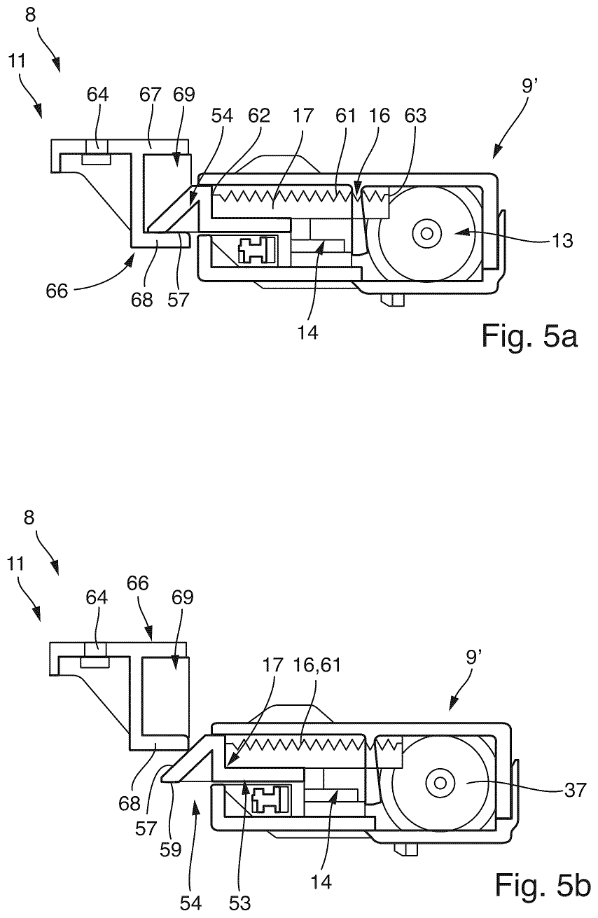

As can also be seen from FIGS. 2 and 3, the second lever arm 44 carries a projection 51 that projects in a direction substantially perpendicular to a pivot plane of the lever element 14 defined by the two lever arms 43, 44 and serves to enable emergency unlatching of the storage compartment latch 9′. For this purpose, the housing 12 has a through-opening 52 recessed in the housing cover 21, and the projection 51 is arranged such that it is opposite the through-opening 52 and preferably also projects slightly outwards through the through-opening 52, as also shown, for example, in FIGS. 5a and 5b. In any case, the projection 51 can be grasped by hand or with a tool from the outside and pivoted in order to be able to unlatch the storage compartment latch 9′ and open the glove compartment 2 in an emergency, in the event of a failure of the electric motor 37 or the power supply.

The storage compartment latch 9′ further includes the locking bolt 17, which has an elongated base body 53, which is designed here, for example, in the form of a straight cylinder with a rectangular outer surface, and a bolt head 54, which is firmly connected to the base body 53, preferably integrally formed therewith. The base body 53 is displaceably mounted in the housing 12 along its longitudinal extent. For this purpose, the base body 53 has two guide strips 56a, 56b, which are provided on two opposite sides along its longitudinal extent in order to be slidably guided in the guide rails 23a, 23b of the base plate 18 of the housing 12. The locking bolt 17 is guided linearly with little play during its sliding movement in the housing 12 in both directions perpendicular to the opening 33 of the housing 12 by the guide rails 23a, 23b and the guide strips 56a, 26b cooperating therewith.

As can be seen from FIGS. 2 and 3, the bolt head 54 is essentially wedge-shaped in side view and comprises a locking surface 57 which is essentially flush with a surface 58 of the base body 53, and an inclined run-up surface 59 opposite the locking surface 57, which extends at an angle different from 0° and 90°, for example an angle of approximately 45°, relative to the locking surface 57. The locking surface 57 is intended to cooperate with the locking part 11 in order to latch the storage compartment latch 9′ in the closed state of the flap 7 and to hold it in the latched position. The run-up surface 59 serves to cooperate with the locking part 11 when closing the flap 7 in order to press the locking bolt 17 into the housing 12 against the action of the preloading device 16 in order to enable the flap 7 to be closed. For example, a helical or compression spring 61, which is arranged inside the base body 53 and supported between a rear side 62 of the locking head 54 and a support wall 63 formed, for example, on the base plate 18, can serve as the preloading device 16. The compression spring 61 is arranged to preload the locking bolt 17 outwards in the direction from the interior space 22 toward its extended position. The design could also be modified to use a tension spring, and other preloading means, such as leaf springs, wave springs, or the like, could be used. However, the compression spring used here simplifies the design.

As can be seen in particular from FIG. 3, the base body 53 of the locking bolt 17 carries, at the end opposite the bolt head 54, a projection or lug 60 which projects from the surface 58 of the base body 53 which is continuous with the locking surface 57 of the bolt head 54. The lug 60 is arranged and configured to engage with the lever element 14 in order to convert a pivoting movement of the lever element 14 into a sliding movement of the locking bolt 17. In the illustrated embodiment, the first free end 46 of the first lever arm 43 and the lug 60 are suitably positioned with respect to one another so that the first free end 46 comes into direct engagement with the lug 60 in order to transmit the force directly, without any intervening means, from the lever element 14 to the lug 60 and consequently to the locking bolt 17.

An exemplary locking part 11, which cooperates with the storage compartment latch 9′ to form the storage compartment latching system 8 according to the present disclosure, is shown in particular in FIGS. 5a and 5b. However, it should be noted that the locking part 11 shown here as a striker part is purely exemplary and the locking part 11 can be configured in many different ways, for example as a locking hook, in order to achieve the latching function together with the storage compartment latch 9′. In the illustrated embodiment, the locking part 11 comprises a base section 64, which is configured for mounting on the flap 7 or the storage compartment housing 4, for example by screwing or riveting, and a latching section 66, which is preferably formed integrally with the base section 64. The latching section 66 here includes two spaced-apart and parallel wall elements 67, 68, which define between them a receiving space 69, which is arranged and dimensioned to receive the bolt head 54 of the locking bolt 17 in its fully extended and latched position, as shown in FIG. 5a. The wall element 68, which is spaced from the base section 64, is further provided to act on the inclined run-up surface 59 of the bolt head 54 in order to push the locking bolt 17 into the housing 12 when the flap 7 is being closed, as can also be seen in FIG. 5b.

The operation of the storage compartment latch 9′ according to the present disclosure is preferably controlled by a control device 71, which is only shown schematically in FIG. 1. The control device 71 can be a hardware-based electronic control device or a processor-based control device executing a software or firmware program. It can be part of a vehicle control system or a controller that controls certain functions of the vehicle. The control device 71 is connected to a power supply 72, which can in particular be coupled to the power supply of the vehicle or integrated into it and which is electrically connected via a connecting line 73 to the storage compartment latch 9′, in particular to the connection 34 for supplying power to the electric motor 37.

The operation of the storage compartment latching system 8 according to the present disclosure described so far will now be described with particular reference to FIGS. 4-6. FIGS. 4a-4c show a plan view of the storage compartment latching system 8 in different positions during the unlatching and opening process, with the housing cover 21 removed to reveal the internal latching mechanism. FIGS. 5a and 5b show cross-sections through the storage compartment latching system 8 in a plane oriented perpendicular to the plane of illustration in FIGS. 4a-4c, substantially through the center of the locking bolt 17. FIGS. 6a-6c show views corresponding to FIGS. 4a-4c for different positions during a latching and closing process. The storage compartment latching system 8 according to the present disclosure operates as follows:

It is assumed that the locking bolt 17 is in the fully extended position shown in FIGS. 4a and 5a, in which the bolt head 54 protrudes outwardly through the opening 33 from the interior space 22 of the housing 12 and into the receiving space 69 of the locking part 11. The wall element 68 of the locking part 11 cooperates with the locking surface 57 of the bolt head 54 to prevent the flap 7 from opening, so that the storage compartment latching system 8 is latched and the glove compartment 2 is closed.

If the storage compartment latching system 8 is to be unlatched and the flap 7 is to be opened in order to open the glove compartment 2, a user can signal the desire to open the storage compartment 1 by means of a suitable input device, via a touch switch or a button on a control panel, by voice or movement input or the like. A sensor, which is not shown in detail here, can detect this input and transmit an input signal indicating this desire to the control device 71. The control device 71 receives the input signal and then causes the electric motor 37 to be supplied with a current pulse from the power supply 72 in order to retract the locking bolt 17 into the housing 12. The current pulse has a limited duration of, for example, 50 ms, generally less than 70 ms or even less than 30 ms, which is sufficient to retract the locking bolt head from its fully extended position according to FIG. 4a into its fully retracted position, as shown in FIG. 4b.

While the power supply 72 supplies the current pulse to the electric motor 37, the output shaft 38 of the electric motor 37 is rotated. Via the worm wheel 39 and the gear wheel segment 48 of the worm gear 41, the rotational movement of the output shaft 38 is converted into a pivoting movement of the lever element 14 in the direction shown in FIG. 4b, here clockwise, in which the first lever arm 43 of the lever element 14 is pivoted in a direction away from the locking part 11 toward the electric motor 37. The first lever arm 43 acts directly on the lug 60 of the locking bolt 17 and carries it along. As a result, the locking bolt 17 is pushed away from the locking part 11 into the interior space 22 in a manner guided by the guide elements 23a, 23b, 56a, 56b, until the locking bolt 17 reaches the fully retracted position shown in FIG. 4b. In this position, the bolt head 54 has completely left the receiving space 69 of the locking part 11, so that the flap 7 can be folded open and the glove compartment 2 can be opened.

Although this is not shown here, in preferred embodiments, a mechanism, for example a biasing mechanism or a drive mechanism with force transmission means, is provided to automatically push the flap 7 into an at least partially open position upon unlatching the latching system 8. In this position, the bolt head 54 is located outside the receiving space 69 of the locking part 11, as also shown, for example, in FIG. 5b. The biasing or drive mechanism could also be arranged to fully open the flap 7.

As soon as the control device 71 causes the power supply to the electric motor 37 to be interrupted, i.e., the current pulse ceases, the compression spring 61 can act on the locking bolt 17 to push it outwards again from the interior space 22 of the housing 12. The spring force pushes the locking bolt 17 out of the housing 12 until the bolt head 54 reaches its fully extended position. At the same time, the lug 60 of the locking bolt 17 presses against the first free end 46 of the first lever arm 43, causing the lever arm 43 and thus the entire lever element 14 to rotate about the pivot pin 24 in the direction shown in FIG. 4c, here counterclockwise. The co-rotated second lever arm 44 interacts via the gear wheel segment 48 with the worm wheel 39 on the output shaft 38 of the electric motor 37 to convert the pivoting movement of the lever element 14 into a rotational movement of the output shaft 38. This is permitted by the non-self-locking worm gear 41. Thus, the lever element 14 can be returned to its initial position. FIG. 4c shows the state in which the locking bolt 17 is in the fully extended position outside the locking part 11 and the lever element 14 is rotated back to its initial position.

If the glove compartment 2 is to be closed again, the flap 7 is folded back until the flap 7 reaches the storage compartment housing 4 and the storage compartment latch 9′ and the locking part 11 reach the relative position shown in FIGS. 5b and 6a. In this position, the run-up surface 59 of the bolt head 54 comes into contact with the wall element 68 of the locking part 11, whereby as the flap 7 is pressed closed further, the wall element 68 presses against the inclined run-up surface 59, so that a force component acting on the locking bolt 17 in the longitudinal direction of the latter pushes the locking bolt 17 into the housing 12. As the flap 7 continues to be closed, the locking bolt 17 is pushed in to its fully retracted position until the bolt head 54 can pass the wall element 68. This fully retracted position is shown in FIG. 6b. Advantageously, only the locking bolt 17 is pushed into the housing 12, while the lever element 14 is decoupled from the locking bolt 17 and is not moved.

As soon as the bolt head 54 has passed the wall element 68 and is opposite the receiving space 69 of the locking part 11, the locking bolt 17 is pressed out of the housing 12 and into the receiving space 69 again under the action of the compression spring 61 or another preloading device 16 until it assumes the fully retracted position shown in FIGS. 6c and 5a, in which the storage compartment latching system 8 is latched again. Again, the locking surface 57 prevents the flap 7 from opening without user input. In an emergency, the storage compartment latching system 8 can be unlatched via the projection 51 protruding from the housing (see FIGS. 5a, 5b).

The storage compartment latching system according to the present disclosure has a relatively simple, compact, and space- and weight-saving design. The construction offers high functional reliability, robustness, and durability. For the user, handling is made easier and comfort is increased. The simple and cost-effective design, manufacture, and assembly of the storage compartment system according to the present disclosure make it particularly suitable for use in the automotive sector. The storage compartment latching system 8 can be used for various storage compartments, including lockable armrests, lockable storage spaces on doors, and the like.

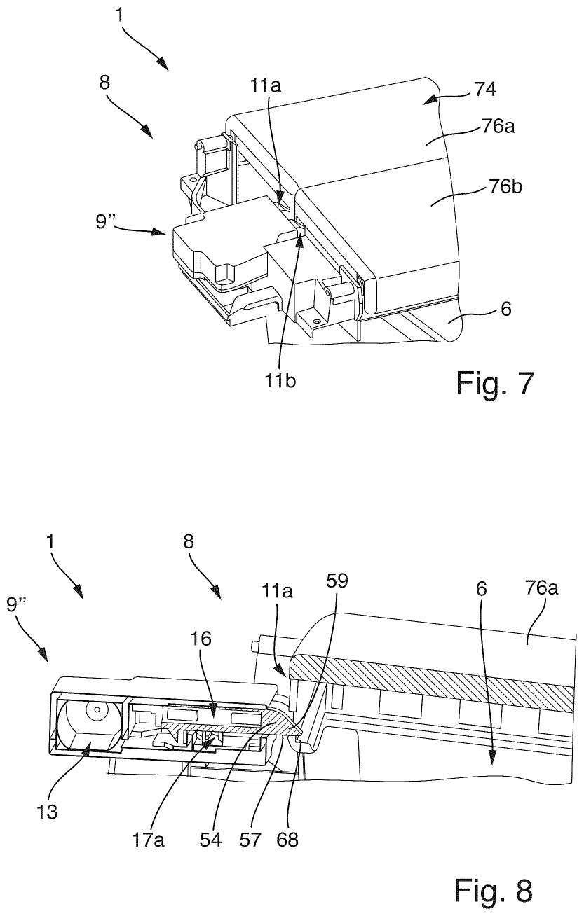

FIGS. 7-12 show a further embodiment of a storage compartment latching system 8 according to the present disclosure with a modified storage compartment latch 9′, which is particularly suitable for latching a storage compartment 1 in the form of a double-leaf armrest 74. To the extent that components of the embodiment of the storage compartment latching system 8 of FIGS. 7-12 correspond to those of FIGS. 2-6, in order to avoid repetition, reference is made to the above description of FIGS. 2-6 using the same reference numerals, which description applies here in the same or analogous manner, unless specifically stated otherwise herein.

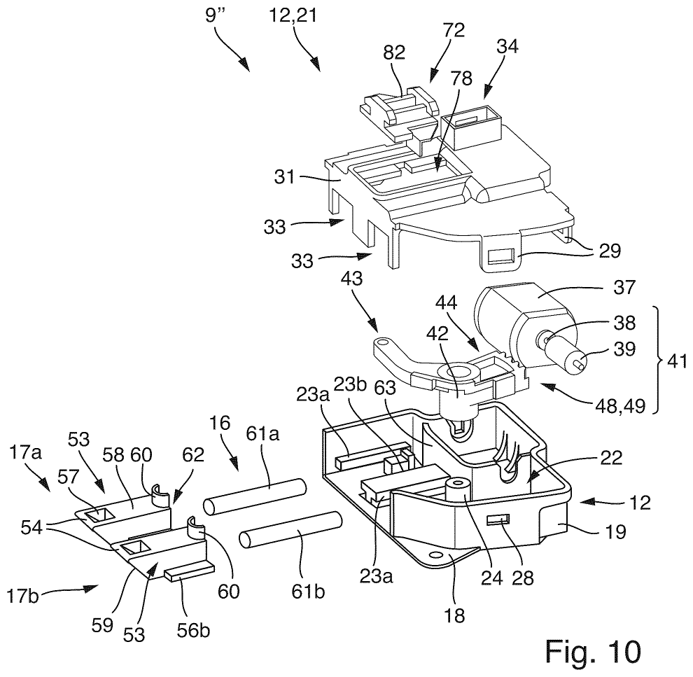

As can be seen from FIGS. 7 and 8, the double-leaf armrest 74 has two cover flaps 76a, 76b, which can be folded out or opened independently of one another to provide access to different areas of the storage space or cavity 6 of the armrest 74. The cover flaps 76a, 76b can be unlatched and opened together and simultaneously, and can be folded closed and latched individually and separately from one another. For this purpose, the storage compartment latch 9″ has two locking bolts 17a, 17b, each of which can be designed essentially identically to the locking bolt 17 of the first embodiment. This can be seen in particular in FIG. 10, which shows the components of the storage compartment latch 9″ in an exploded view. The two locking bolts 17a, 17b are arranged in the housing 12 at a distance from and parallel to one another and are mounted and guided in a displaceable manner. For this purpose, two pairs of guide rails 23a, 23b are formed on the base plate 18 of the housing 12, each of which is assigned to the guide strips 56a, 56b of one of the locking bolts 17a, 17b. Each locking bolt 17a, 17b is biased towards its extended position by a compression spring 61a, 61b or another preloading device 16.

In contrast to the first embodiment according to FIGS. 2-6, the storage compartment latch 9″ additionally has a coupling element 77, which serves to effect a joint, simultaneous displacement of both locking bolts 17a, 17b into the housing upon actuation of the electric motor 37 in order to unlatch both cover flaps 76a, 76b. The coupling element 77 is designed in the form of a slider which is displaceably mounted and guided in the housing 12, in particular in an elongated guide opening 78 in the housing cover 21, and which is operatively coupled between the first lever arm 43 of the lever element 14 and the lugs 60 of both locking bolts 17a, 17. For this purpose, the coupling element 77 has at least one first active surface 79, which engages with the first free end 76 of the first lever arm 63, as well as further active surfaces 81 which are configured to engage with the lugs 60 of the locking bolts 17a, 17b.

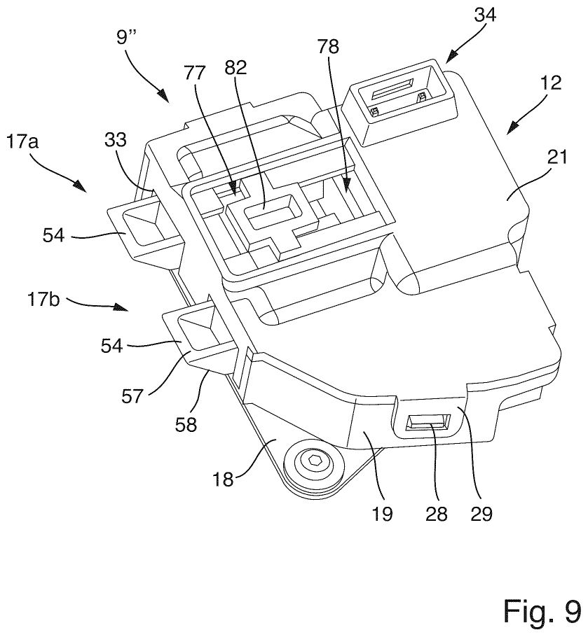

As can be seen in particular from FIG. 9, the guide opening 78 in the housing cover 21 can be designed as a through-opening, and a section 82 of the coupling element 77 can be accessible from the outside through the through-opening 78 in order to enable manual displacement of the coupling element 77, if necessary by means of a tool for emergency unlatching of the storage compartment latch 9″.

The storage compartment latching system 8 with the storage compartment latch 9″ according to FIGS. 7-12 operates substantially in the same way as described above in connection with FIGS. 4-6, for each of the locking bolts 17a, 17b, wherein the coupling element 77 ensures that both locking bolts 17a, 17b are carried along in order to be able to retract them simultaneously into the housing 12 during unlatching.

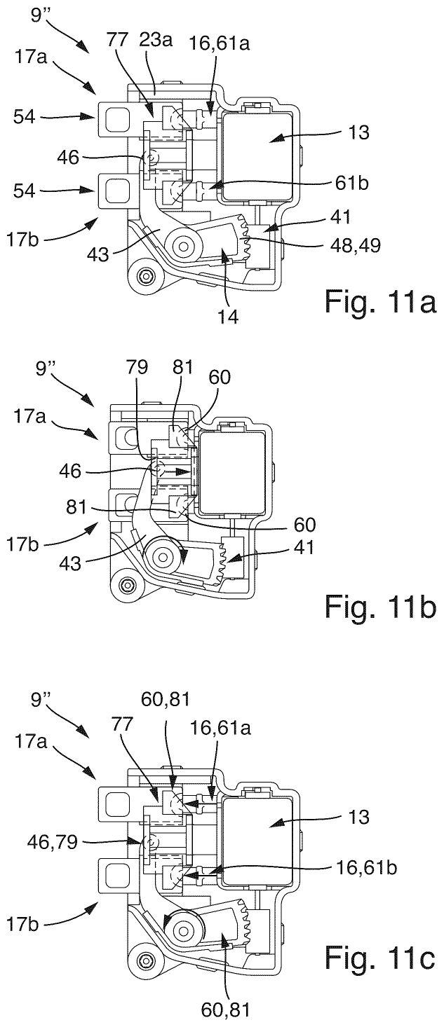

In the latched position, as shown in FIGS. 7 and 8 and also indicated in FIG. 11a, each of the two locking bolts 17a, 17b engages in its associated locking part 11a or 11b, which can be provided, for example, in the form of a latching hook or latching bracket on the associated cover flap 76a, 76b in order to latch the locking bolt 17a or 17b. As soon as the control device 71 triggers an unlatching and opening of the cover flaps 76a, 76b as a result of a request by a user, the electric motor 37 receives a current pulse of limited duration, for example 50 ms, as described above, whereby the electric motor 37 rotates the lever element 14 about the pivot pin 24 in the direction shown in FIG. 11b, here clockwise, via the output shaft 38 and the worm gear 41, whereby the lever element 14 retracts both locking bolts 17a, 17b into the housing 12 via the coupling element 77. More precisely, the first free end 76 of the first lever arm 43 acts on the first active surface 79 of the coupling element 77 during the rotational movement of the lever element 14 in order to displace the coupling element 77 along the guide opening 78.

The coupling element 77 acts on the two lugs 60 of the locking bolts 17a, 17b via the further active surfaces 81 in order to push both locking bolts 17a, 17b together into the interior space 12. FIG. 11b shows the two locking bolts 17a, 17b in their fully retracted position.

As soon as the current pulse ceases and the cover flaps 76a, 76b have been moved into an at least partially open position, for example by a suitable mechanism, such as a biasing mechanism or a drive mechanism with power transmission means, the compression springs 61a, 61b push both locking bolts 17a, 17b outwards again, out of the housing 12, until they reach the fully extended position according to FIG. 11c. At the same time, the lugs 60 act on the first lever arm 43 via the coupling element 77 in order to rotate the lever element 14 about the pivot pin 24 in the direction shown in FIG. 11c, here counterclockwise. By providing the non-self-locking worm gear 41, the lever element 14 can thus be rotated back to its initial position. Advantageously, the worm wheel element 49 is designed in the form of the gear wheel segment 48 formed on the second lever arm 44.

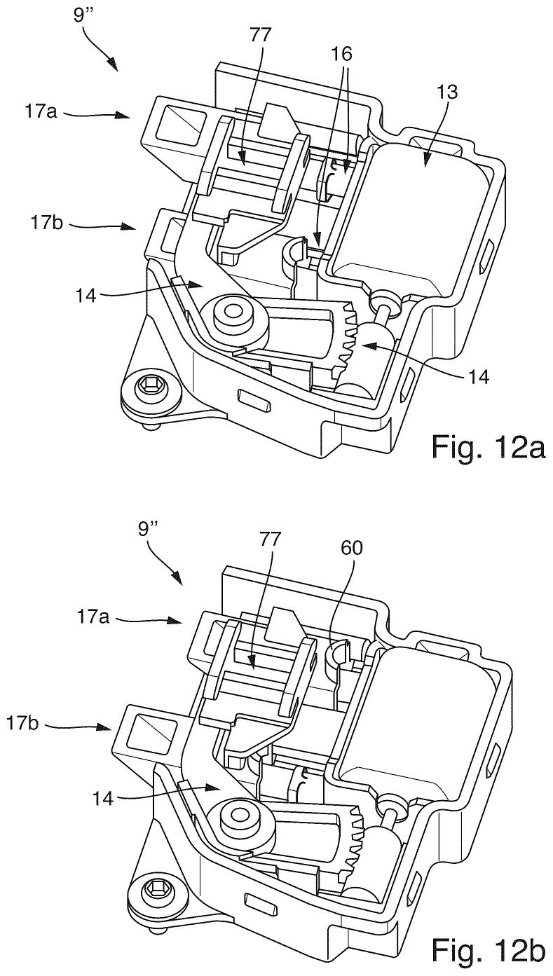

The cover flaps 66a, 66b can be closed independently and separately from one another, whereby the state of the other cover flap 76a or 76b is not affected. For example, as shown in FIG. 12a, when the cover flap 76b is closed, the locking bolt 17b is pushed into the housing 12 by the action of the force of the locking part 11b on the run-up surface 59 of the locking bolt 17b, so that the bolt head 54 of the locking bolt 17b can pass a corresponding wall element 68 of the locking part 11b and enter the receiving space 69 of the locking part 11b in order to latch the cover flap 76b. The state of the locking bolt 17a, which is associated with the cover flap 76a, is not affected in any way by this.

Accordingly, when the cover flap 76a is closed, as can be seen from FIG. 12b, the locking bolt 17a is pressed into the housing 12 by the force exerted by the locking part 11a, while the state of the other locking bolt 17b and the other cover flap 76b remains unaffected by this. If one of the cover flaps 76a or 76b is closed and the other cover flap 76b or 76a is being closed, the state of the already closed cover flap 17a or 17b and the associated locking bolt 17a or 17b is not affected by this. They remain closed or latched and are therefore not opened or unlatched. During the individual closing processes, the movements of the locking bolts 17a, 17b are completely decoupled from one another.

A storage compartment latch 9, 9′, 9″ for a storage compartment 1 of a vehicle comprises a housing 12, at least one locking bolt 17, 17a, 17b which is displaceably mounted in the housing 12 and which can be selectively transferred into a position retracted in the housing 12 or a position extended from the housing 12, an electric drive 13 arranged in the housing 12 with an electric motor 37 and a worm gear 41 driven by the electric motor 37, and a lever element 14 which is pivotally mounted in the housing 12 and which is directly operatively connected to the worm gear 41 in such a way that a rotational movement of the electric motor 37 is converted directly into a pivoting movement of the lever element 14 via the worm gear 41, wherein the lever element 14 is further operatively connected to the at least one locking bolt 17, 17a, 17b in such a way that a pivoting movement of the lever element 14 is converted into a displacement movement of the at least one locking bolt 17, 17a, 17b.

1. A storage compartment latch for a storage compartment of a vehicle, comprising:
a housing;
at least one locking bolt comprising a base body which is displaceably mounted in the housing and a bolt head which is firmly connected to the base body and which is selectively transferrable into a fully extended position or a fully retracted position by displacing the base body;
an electric drive arranged in the housing and comprising an electric motor and a worm gear driven by the electric motor; and
a lever element which is pivotally mounted in the housing and is directly operatively connected to the worm gear in such a way that a rotational movement of the electric motor is directly converted into a pivoting movement of the lever element via the worm gear, wherein the lever element has a lever arm which engages with the base body of the at least one locking bolt in order to convert a pivoting movement of the lever element into a displacement movement of the at least one locking bolt.

2. The storage compartment latch according to claim 1, wherein the housing comprises a base plate, a side wall firmly connected to the base plate and a housing cover which is detachably connected to the side wall and/or the base plate, wherein at least one opening is defined on a front side of the housing, through which the bolt head protrudes outwards from the housing in the fully extended position.

3. The storage compartment latch according to claim 1, wherein the base body of the at least one locking bolt has an elongated shape and carries guide strips which extend along its longitudinal extent on two opposite sides and which are displaceably guided in guide rails formed on the housing.

4. The storage compartment latch according to claim 1, wherein the bolt head of the at least one locking bolt is formed with a locking surface and an inclined run-up surface opposite the locking surface.

5. The storage compartment latch according to claim 1, wherein the at least one locking bolt carries a lug projecting beyond a surface of the base body and arranged and adapted to engage the lever element.

6. The storage compartment latch according to claim 1, wherein the at least one locking bolt is preloaded by a preloading device, in particular a compression spring, in a direction of its extended position.

7. The storage compartment latch according to claim 1, wherein the worm gear is designed as a non-self-locking gear.

8. The storage compartment latch according to claim 1, wherein the worm gear comprises a worm shaft, which is formed by a helical output shaft of the electric motor, or a worm wheel, which is mounted on the output shaft of the electric motor in a rotationally fixed manner, and a worm wheel element, which is formed directly on the lever element in one piece therewith.

9. The storage compartment latch according to claim 8, wherein the worm wheel element is formed as a gear wheel segment which is delimited by a segment angle range which is less than 45°.

10. The storage compartment latch according to claim 9, wherein the lever element is a two-sided lever element having the lever arm which engages with the at least one locking bolt and a further lever arm on which the gear wheel segment is formed.

11. The storage compartment latch according to claim 10, wherein the further lever arm carries a projection which protrudes in a direction substantially perpendicular to a pivoting plane of the lever element, the housing has a through-opening and the projection is accessible from the outside through the through-opening in order to enable emergency unlatching of the storage compartment latch.

12. The storage compartment latch according to claim 1, wherein the at least one locking bolt is a single locking bolt and the lever element is directly engaged with the single locking bolt.

13. The storage compartment latch according to claim 1, wherein the at least one locking bolt comprises a first elongated locking bolt and a second elongated locking bolt which are arranged parallel and spaced apart next to one another and are displaceably mounted in the housing, wherein each of the first and second elongated locking bolts is preloaded in a direction of its extended position by a separate preloading device, in particular a compression spring.

14. The storage compartment latch according to claim 13, wherein a coupling element is displaceably mounted in the housing and is operatively coupled between the lever element and the first and second locking bolts in order to convert a pivoting movement of the lever element into a coupled displacement movement of both the first and the second elongated locking bolts, wherein the first and the second elongated locking bolts are each arranged to be pushed into the housing independently of the other elongated locking bolt and the coupling element when an external force acts on their associated bolt head.

15. The storage compartment latch according to claim 14, wherein a portion of the coupling element is accessible from the outside through a through-opening of the housing in order to enable emergency unlatching of the storage compartment latch.

16. The storage compartment latch according to claim 1, wherein the storage compartment latch is associated with a control device which is arranged to receive an input signal indictive of an operator's desire to open the storage compartment and then to cause the electric motor to be supplied with a current pulse of limited duration in order to effect a transfer of the bolt head into its fully retracted position.

17. A storage compartment of a vehicle, in particular a motor vehicle, the storage compartment comprising:
a storage compartment housing defining a cavity;
at least one cover flap which is movably arranged on the storage compartment housing, wherein the at least one cover flap is movable between an open position in which the cavity is open to the outside and a closed position in which the cavity is closed to the outside;
a storage compartment latch according to claim 1, which is attached to one of the at least one cover flap and the storage compartment housing, and
a locking part attached to the other of the at least one cover flap and the storage compartment housing, which is arranged to cooperate with the bolt head of the at least one locking bolt of the storage compartment latch in order to latch the at least one cover flap in the closed position.

18. The storage compartment according to claim 17, which is a glove compartment which is formed in a dashboard of a motor vehicle or is a separate component insertable into the dashboard, or is an armrest which is provided in an area of a center console or a rear seat console of a motor vehicle and comprises a lockable storage space.

19. The storage compartment latch according to claim 9, wherein the segment angle range is less than 30° or less than 20°.

20. The storage compartment latch according to claim 2, wherein the base body of the at least one locking bolt has an elongated shape and carries guide strips which extend along its longitudinal extent on two opposite sides and which are displaceably guided in guide rails formed on the housing.
